(19) United States
(12) Patent Application Publication
(10) Pub. No.: US 2026/0033461 A1
(43) Pub. Date: Feb. 5, 2026

(54) DOG LEASH WITH EMBEDDED WASTE MANAGEMENT SYSTEM

(71) Applicant: EDAMAME PET, LLC, Portsmouth, NH (US)

(72) Inventor: Ryan Price, Portsmouth, NH (US)

(21) Appl. No.: 19/258,431

(22) Filed: Jul. 2, 2025

Related U.S. Application Data
(60) Provisional application No. 63/678,632, filed on Aug. 2, 2024.

(51) Int. Cl. A01K 27/00

(52) U.S. Cl. CPC A01K 27/008; A01K 27/003

(57) ABSTRACT

The present disclosure relates to a dog leash with embedded waste management system and is configured to allow for safe and efficient sanitary bag dispensing. More specifically, the dog leash comprises a stationary internal storage compartment that allows a handler to remove a sanitary bag from a roll while maintaining control of their pet.

### CROSS REFERENCE TO RELATED APPLICATION

This application claims the benefit of and takes priority from U.S. Provisional Patent Application No. 63/678,632 filed on Aug. 2, 2024, the contents of which are herein incorporated by reference.

### BACKGROUND OF THE INVENTION

### Field of the Invention

The present disclosure relates to the field of pet leashes and specifically those with embedded waste management systems.

### Description of the Related Art

In many public places, handlers are required by law to constrain their pets through the use of a leash and to clean up after them. Handlers often have to pick between bulky leash attachments to hold sanitary rolls and bags, or holding the bags in their only free hand, if they remember them at all.

Pet waste management attachments and add-ons currently on the market offer limited storage and complicated loading mechanisms that fail to satisfy all of the needs of pet handlers.

### SUMMARY OF THE INVENTION

The instant apparatus and system, as illustrated herein, is clearly not anticipated, rendered obvious, or even present in any of the prior art mechanisms, either alone or in any combination thereof.

It is an object of the present invention to provide a dog leash with embedded waste management system configured to minimize leash bulkiness, maximize sanitary roll storage, and allow for easy sanitary roll loading and bag dispensing. This objective can be achieved by the dog leash according to the present model, the dog leash with embedded waste management system comprising a stationary internal storage compartment and a set of slits serving as used bag holders. The dog leash is preferably made of leather, allowing for a press and tear method of dispensing the sanitary bags.

Ideally, the leash is made of one consistent piece of material, forming two ends. The first end comprises a handle and the second end comprises a clasping mechanism to preferably attach to the collar or harness of a pet.

The stationary internal storage compartment within the leash body comprises an opening for loading sanitary rolls directly into the leash, which is closed with a snap closure to help hold the rolls in place when the leash is in use. The stationary internal storage compartment joins together the leash body, and is not an external stationary internal storage compartment attached to the outside of a leash.

The stationary internal storage compartment houses two rolls of sanitary bags, held next to each other, end to end. The two rolls of bags can be dispensed at the same time, or one at a time, through small openings on either side of the snap closure. Within the stationary internal storage compartment is an at least one internal divider to help the two rolls to stay in position, allowing for easy dispensing.

In one embodiment, the leash is made of leather allowing for a press and tear method of dispensing the sanitary bags when the snap closure is secured. This method allows the handler to keep at least one hand on the leash when dispensing a sanitary bag. Because the sanitary rolls are housed internally in the leash, the handler's first hand holds the leash while performing the “press” step upon the stationary internal storage compartment, and the handler's second hand “tears” the individual bag protruding from a small opening on either side of the snap closure.

In one embodiment, the leash includes a set of slits that serve as used sanitary bag holders. The set of slits preferably lays between the stationary internal storage compartment and the second end of the leash. The holder is comprised of a narrow slit in the material forming the leash. The top of a used bag can be inserted into this slit. Once inserted, the bag will be held in the slit until the handler can properly dispose of it.

There has thus been outlined, rather broadly, the more important features of a dog leash with embedded waste management system, the description thereof that follows may be better understood, and in order that the present contribution to the art may be better appreciated. There are additional features of the system that will be described hereinafter and which will form the subject matter of the claims appended hereto.

In this respect, before explaining at least one embodiment of the system in detail, it is to be understood that the system is not limited in its application to the details of construction, assembly and arrangements of the components set forth in the following description or illustrated in the drawings. The system is capable of other embodiments and of being practiced and carried out in various ways. Also, it is to be understood that the phraseology and terminology employed herein are for the purpose of description and should not be regarded as limiting.

These together with other objects of the system, along with the various features of novelty, which characterize the system, are pointed out with particularity in the claims annexed to and forming a part of this disclosure. For a better understanding of the system, its operating advantages and the specific objects attained by its uses, reference should be made to the accompanying drawings and descriptive matter in which there are illustrated preferred embodiments of the system.

The foregoing has outlined the more pertinent and important features of the present device in order that the detailed description of the system that follows may be better understood, and the present contributions to the art may be more fully appreciated. It is of course not possible to describe every conceivable combination of components and/or methodologies, but one of ordinary skill in the art may recognize that many further combinations or permutations are possible. Accordingly, the novel architecture described below is intended to embrace all such alterations, modifications, and variations that fall within the spirit and scope of the appended claims.

### BRIEF DESCRIPTION OF THE DRAWINGS

Advantages of the present device will be apparent from the following brief description of exemplary embodiments thereof; which description should be considered in conjunction with the accompanying drawings. Having thus described the invention in general terms, reference will now be made to the accompanying drawings, which are not necessarily drawn to scale. The system may be more completely understood in consideration of the following detailed description of various embodiments of the system in connection with the accompanying drawings, in which:

FIG. 1 is a perspective side view of one embodiment of a dog leash with embedded waste management system according to the present disclosure.

FIG. 2 is a perspective side view of the first end of one embodiment of a dog leash with embedded waste management system according to the present disclosure.

FIG. 3 is a perspective front view of one embodiment of the stationary internal storage compartment and the set of slits of the dog leash with embedded waste management system according to the present disclosure.

FIG. 4 is a perspective side view of one embodiment of the set of slits of the dog leash with embedded waste management system according to the present disclosure.

FIG. 5 is a perspective cross-sectional view of one embodiment of the stationary internal storage compartment of the dog leash with embedded waste management system according to the present disclosure, illustrating the stationary internal storage compartment.

FIG. 6 is a perspective view of the dog leash with embedded waste management system according to the present disclosure, with the stationary internal storage compartment closed.

FIG. 7 is a perspective view of the dog leash with embedded waste management system according to the present disclosure, with the stationary internal storage compartment open and empty.

FIG. 8 is a perspective view of the dog leash with embedded waste management system according to the present disclosure, with the stationary internal storage compartment open and loaded.

FIGS. 9-13 are alternate embodiments of the stationary internal storage compartment of the dog leash with embedded waste management system according to the present disclosure.

FIG. 14 is an environmental view of the dog leash with embedded waste management system according to the present disclosure.

### DETAILED DESCRIPTION OF THE SEVERAL EMBODIMENTS

The detailed description set forth below is intended as a description of presently preferred embodiments of the system and does not represent the only forms in which the present system may be construed and/or utilized. The description sets forth the functions and the sequence of the steps for producing the system and accompanying apparatus. However, it is to be understood that the same or equivalent functions and sequences may be accomplished by different embodiments and also intended to be encompassed within the scope of the system.

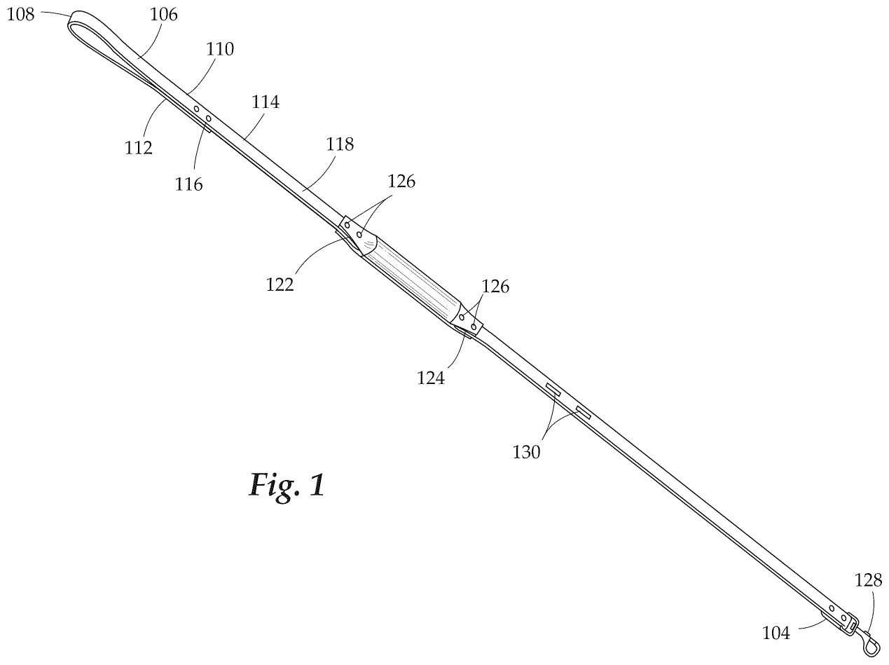

FIG. 1 illustrates one embodiment of a dog leash with an embedded waste management system, wherein a dog leash 100 includes a first end 102 and a second end 104. Preferably, the dog leash 100 comprises a handle 106 located at the first end 102 of the dog leash 100. In this embodiment, the handle 106 comprises a loop 108 in order for a user of the dog leash 100 to grip the handle 106 while walking a dog or similar animal. It may be envisioned in other embodiments that the handle 106 be of different shapes to assist in gripping the dog leash 100. Furthermore, the handle 106 comprises a first end 110 and a second end 112 that meet at a base 114. At the base 114, the first end 110 and the second end 122 come together and are held with an attachment mechanism 116. In one embodiment, the attachment mechanism 116 may include, but is not limited to, rivets, pins, fasteners, or studs.

In this embodiment the leash body 118 comprises two layers that are preferably sewn together. This double layering of the leash body 118 adds durability to the dog leash 100. In other embodiments, especially if the dog leash 100 is made of other materials, including, but not limited to nylon or polyester, it may only comprise a single layer of material.

The base 114 of the handle 106 is further connected to a leash body 118 with a stationary internal storage compartment 120 located in the center of the leash body 118. The stationary internal storage compartment 120 comprises a first end 122 and a second end 124, wherein the first end 122 and the second end 124 are connected to the leash body 118 via a set of attachment mechanisms 126. In one embodiment, the set of attachment mechanisms 126 may include, but is not limited to, rivets, pins, fasteners, or studs. In this embodiment, the stationary internal storage compartment 120 is capable of holding two rolls of sanitary bags next to each other, end to end. In other embodiments, the size of the stationary internal storage compartment 120 may vary and therefore allow for fewer or more rolls to be held within, such as a stationary internal storage compartment 120 that holds a single sanitary roll.

The leash body 118 connects the second end 124 of the stationary internal storage compartment 120 to the second end 104 of the dog leash 100, wherein the second end 104 of the dog leash 100 preferably comprises a metal clasp 128 that attaches to a dog collar or harness. In this embodiment, the dog leash 100 is a length of 5.5 feet, but the length may vary in other embodiments.

The portion of the leash body 118 connecting the second end 124 of the stationary internal storage compartment 120 to the second end 104 of the dog leash 100 comprises a set of slits 130. The set of slits 130 serve as holders for used sanitary bags. The tops of used sanitary bags can be threaded through the set of slits 130, which hold the used sanitary bags in place until they can be disposed of by the user. The placement of the set of slits 130 on the lower half of the leash body 126 allow the used sanitary bags to be held in place without interfering with the user's control of the dog leash 100. Preferably, the slits of the set of slits 130 are each 1.25 inches long.

In other embodiments, the set of slits 130 may be located at other locations on the leash body 126. Further, in other embodiments, the slits of the set of slits 130 may be of different lengths.

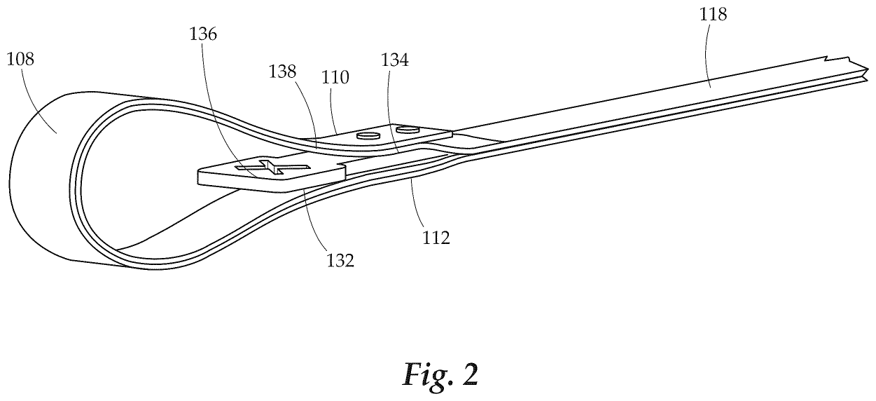

In other embodiments, a used bag holder 132 is contained within the loop 108 of the handle 106. In this embodiment, between the first end 110 and the second end 112 of the handle 106 is a used bag holder 132, as shown in FIG. 2. The used bag holder 132 is preferably one piece of leather or rubber that has a narrow end 134 and a wide end136. The narrow end 134 lays between the first end 110 and the second end 112 of the handle 106, while the wide end 136 protrudes into the loop 108 of the handle 106. The wide end 136 of the used bag holder 132 comprises an X-shaped slot 138, in which a used sanitary bag can be inserted and held.

The handle 106, stationary internal storage compartment 120, and leash body 118 are all preferably made of leather. Leather provides both durability and suppleness to the dog leash 100. Specifically, the stationary internal storage compartment 120 being made of leather allows a user to remove a bag via a press and tear method. Because leather is malleable, the user can press down on the stationary internal storage compartment 120, keeping the loaded sanitary roll from moving, while ripping off an individual bag with their second hand. This allows the user to always keep at least one hand on the dog leash 100. In other embodiments, the handle 106, stationary internal storage compartment 120, and leash body 126 may be made of other supple materials, including, but not limited to nylon or polyester.

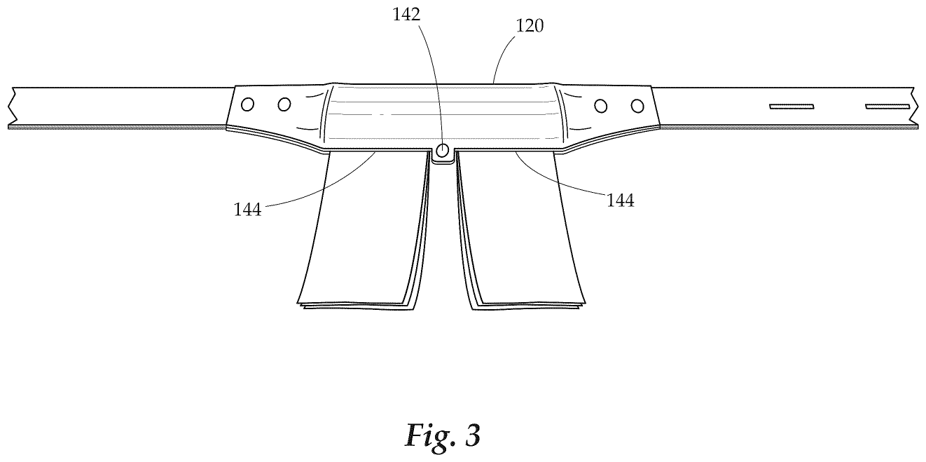

FIG. 3 illustrates one embodiment of a waste management system, wherein the stationary internal storage compartment 120 of the dog leash 100 is loaded with sanitary bag rolls. Once the sanitary rolls are loaded into a hollow chamber 140 of the stationary internal storage compartment 120, a clasp mechanism 142 is secured, forming an at least one small opening 144 from which the individual bags are dispensed. In this embodiment, two rolls fit in the stationary internal storage compartment 120 side by side and can be dispensed from the at least one small opening 144 at the same time. Furthermore, the loaded rolls do not affect the use of the dog leash 100. Specifically, the stationary internal storage compartment 120 does not interfere with the handle 106, the leash body 118, nor the metal clasp 128 as do many traditional bag attachments due to sliding and swinging.

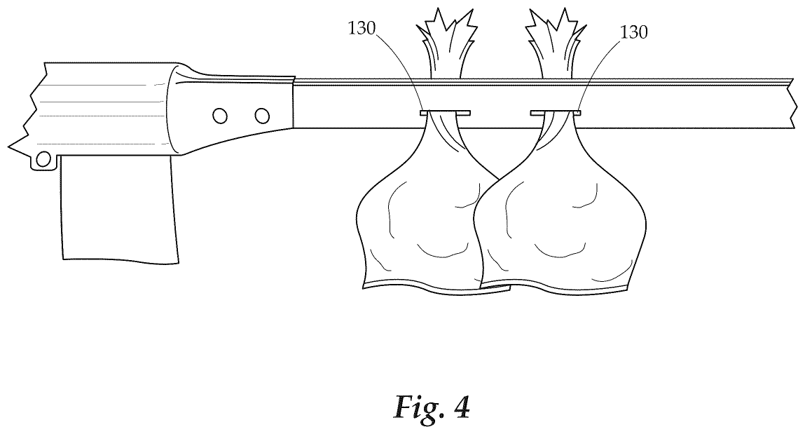

FIG. 4 illustrates one embodiment of a dog leash with embedded waste management system, wherein the set of slits 130 is loaded with used sanitary bags. As shown, once full, the top of the sanitary bags can be twisted and threaded through the set of slits 130. Once threaded through the set of slits 130, the sanitary bags are held in place until they can be disposed of by the user. In other embodiments, set of slits 130 may be spaced differently along the leash body.

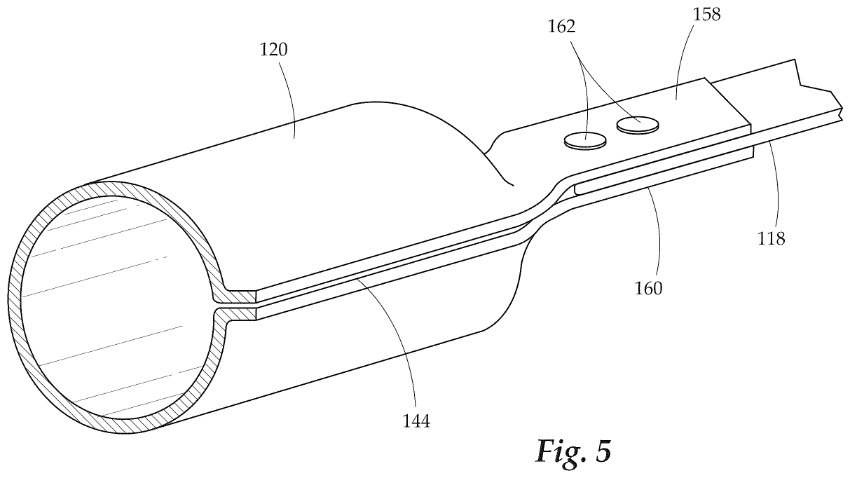

FIG. 5 illustrates a cross-sectional view of one embodiment of the stationary internal storage compartment 120. The stationary internal storage compartment 120 comprises a hollow chamber 140 in which the rolls of sanitary bags can be loaded. In this preferred embodiment, a set of top flaps 154, 158 and a set of bottom flaps 156, 160 of the stationary internal storage compartment 120 lay on top and bottom of the leash body 118, respectively. These flaps are then secured with a securing mechanism 162. The securing mechanism 162, may be, but is not limited to, rivets, pins, fasteners, or studs. In other embodiments, the leash body 118 and the piece of material comprising the stationary internal storage compartment 120 are continuous.

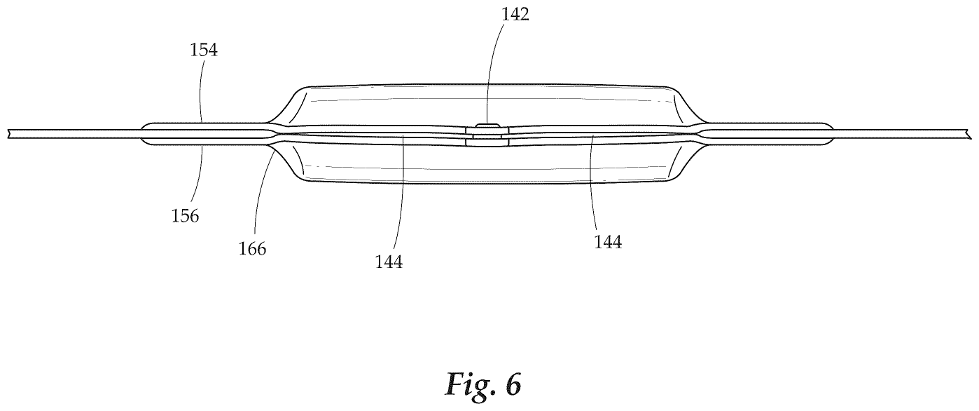

FIG. 6 illustrates a perspective view of one embodiment of the stationary internal storage compartment when it is closed. The stationary internal storage compartment 120 comprises an open side 166, which is closed via the clasp mechanism 142. The closing of the clasp mechanism 142 creates the at least one small opening 144 from which sanitary bags can be dispensed. The rolls of sanitary bags can be dispensed at the same time, or one at a time, through the at least one small opening 144.

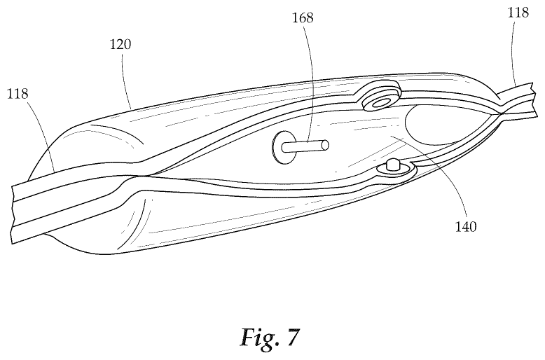

FIG. 7 illustrates one embodiment of the stationary internal storage compartment 120 when it is empty and open. In this embodiment, the hollow chamber 140 comprises an at least one internal divider 168. The at least one internal divider 168 helps to keep the bags aligned when loaded into the hollow chamber 140. Further, it allows the user to only load one roll of sanitary bags if desired by holding the single roll of sanitary bags in place.

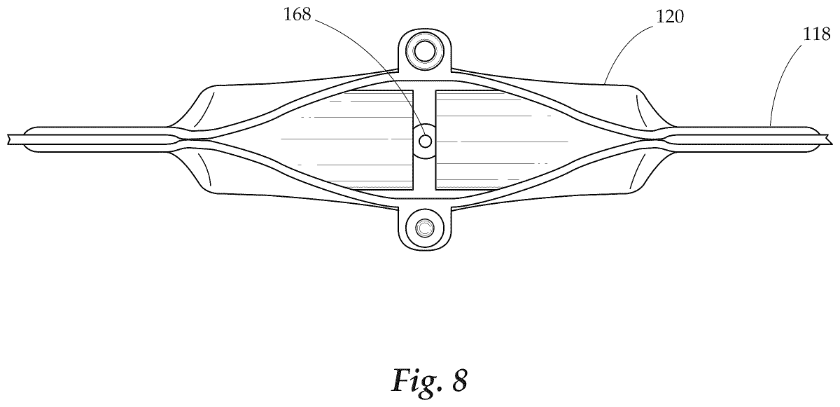

FIG. 8 illustrates one embodiment of the stationary internal storage compartment 120 when it is loaded and open. In this embodiment, the at least one internal divider 168 sits between the loaded rolls of bags, helping to keep them aligned. In this embodiment, the at least one internal divider 168 is a male rivet, but may differ in other embodiments.

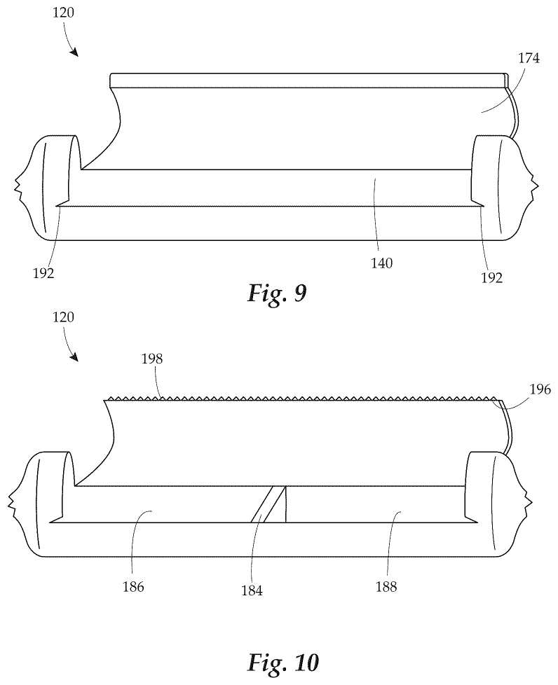

FIGS. 9-13 illustrate alternate embodiments of the stationary internal storage compartment 120. As shown in FIG. 9, in an alternate embodiment, the stationary internal storage compartment 120 is made of a single piece of material. A door 174 opens along a pivot point 184 at a back 194 of the stationary internal storage compartment 120.

In this embodiment, the door 174 can be peeled back in order to reveal the hollow chamber 140 in which the rolls are loaded. In this embodiment, the door 174 does not need to be peeled back for the bags to be dispensed. The bags will flow freely out of the stationary internal storage compartment 120 when the door 174 is closed as there will still be an at least one small opening 144. Furthermore, a front edge 190 of the stationary internal storage compartment 120 comprises at least one divot 192, wherein the outside edges of the bags being dispensed enter the divot 192.

FIG. 10 illustrates an alternate embodiment in which the hollow chamber 140 of the stationary internal storage compartment 120 comprises a perpendicular divider 184, wherein the perpendicular divider 184 separates the stationary internal storage compartment 120 into a first section 186 and a second section 188, each of which holds its own roll of sanitary bags. Additionally, in this embodiment, a top edge 196 of the door 174 comprises a set of teeth 198.

The variations in these embodiments promote smooth dispensing. The perpendicular divider 184 keeps the rolls from interfering with each other in the stationary internal storage compartment 120, the at least one divot 192 keeps the bags aligned, and the set of teeth 198 make it possible to rip off a bag with less force.

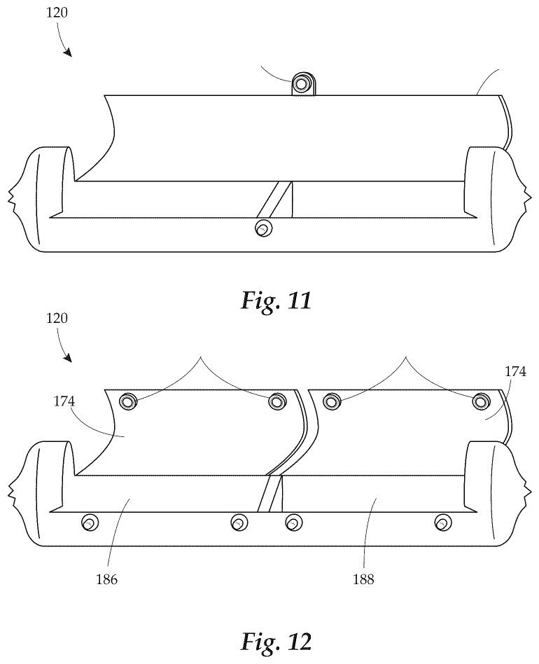

FIG. 11 illustrates another alternate embodiment of the stationary internal storage compartment 120, wherein the top edge 196 of the door 174 comprises a securement mechanism 200. When secured, the securement mechanism 200 serves to separate the bags of different rolls protruding at the same time. In one embodiment, the securement mechanism 200 may include, but is not limited to, a snap closure, a hook and loop fastener, or a magnetic snap.

FIG. 12 illustrates an alternate embodiment of the stationary internal storage compartment 120, wherein the first section 186 and the second section 188 each have their own door 174. In this embodiment, each door 174 further comprises a set of securement mechanisms 202. When secured, the bags dispense between the set of securement mechanisms 202 on their corresponding door 174.

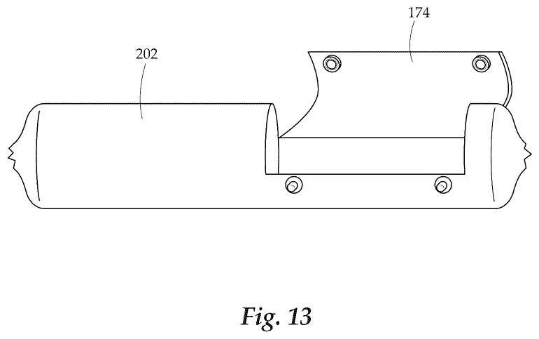

FIG. 13 illustrates an alternate embodiment of the stationary internal storage compartment 120, wherein the door 174 does not span the entirety of a top 204 of the stationary internal storage compartment120.

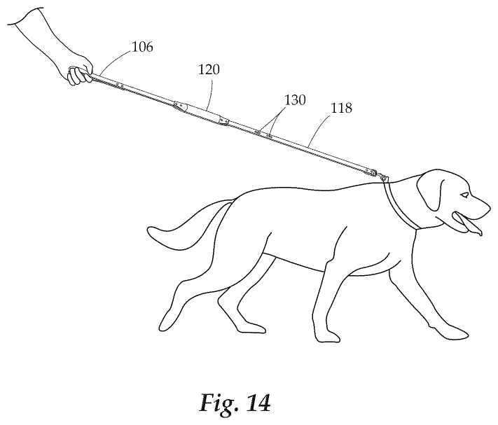

FIG. 14 illustrates an environmental view of the dog leash 100 in use. In this embodiment, the location and design of the stationary internal storage compartment 120 and set of slits 140 allow these features of the dog leash 100 to be used without interfering with the user's control.

While the system is amenable to various modifications and alternative forms, specifics thereof have been shown by way of example in the drawings and will be described in detail. It should be understood, however, that the intention is not to limit the system to the particular embodiments described. On the contrary, the intention is to cover all modifications, equivalents, and alternatives falling within the spirit and scope of the system.

What is claimed is:

1. A dog leash with embedded waste management system comprising:
a handle at a first end of the dog leash;
a clasping mechanism at a second end of the dog leash;
a leash body between the handle and clasping mechanism; and
a stationary internal storage compartment within the leash body,
wherein the stationary internal storage compartment further comprises a hollow chamber to hold an at least one roll of pet sanitary bags.

2. The dog leash with embedded waste management system of claim 1, wherein the stationary internal storage compartment further comprises an open side which serves as both a loading point and a dispending point for the rolls of sanitary bags.

3. The dog leash with embedded waste management system of claim 2, wherein the stationary internal storage compartment further comprises an at least one internal divider that separates the at least one roll of pet sanitary bags.

4. The dog leash with embedded waste management system of claim 1, wherein the malleable material forming the stationary internal compartment allows for a press-and-tear mechanism of dispensing the at least one roll of pet sanitary bags.

5. The dog leash with embedded waste management system of claim 1, wherein the leash body further comprises a set of slits in which used pet sanitary bags can be held.

6. The dog leash with embedded waste management system of claim 1, wherein the handle, the leash body, and the stationary internal storage compartment are all made of the same malleable material.
